(19) United States
(12) Patent Application Publication
(10) Pub. No.: US 2007/0291938 A1
(43) Pub. Date: Dec. 20, 2007

(54) System, method and apparatus for transmitting high definition signals over a combined fiber and wireless system

(75) Inventors: Tandhoni S. Rao, Ashland, MA (US); Samuel J. MacMullan, Carlisle, MA (US); Steven S. Fastert, Chelmsford, MA (US)

Correspondence Address: FIALA & WEAVER, P.L.L.C.;C/O INTELLEVATE, P.O. BOX 52050, MINNEAPOLIS, MN, 55402, US

(73) Assignee: Radiospire Networks, Inc., Concord, MA (US)

(21) Appl. No.: 11/546,381

(22) Filed: Oct. 12, 2006

Related U.S. Application Data
(60) Provisional application No. 60/814,879, filed on Jun. 20, 2006.

(51) Int. Cl. H04N 7/167

(52) U.S. Cl. 380/210

(57) ABSTRACT

A system, method, and apparatus that improves the efficiency of HD content delivery systems. An embodiment of the invention eliminates unnecessary encoding overhead due to TMDS encoding in HD content delivery systems. An embodiment of the invention further allows for increased error protection at lower overhead in HD content delivery systems. Furthermore, embodiments of the present invention provide less expensive and more efficient techniques for transmitting content protection information in HD content delivery systems. The invention is applicable to HD content delivery systems such as DVI and HDMI systems, including systems that employ novel data transmission techniques of the present invention as well as conventional content delivery systems. The invention is applicable to copper and fiber HD content delivery systems.

### CROSS-REFERENCE TO RELATED APPLICATIONS

The present application claims the benefit of U.S. Provisional Patent Application No. 60/814,879, entitled “System, Method and Apparatus for Transmitting High Definition Signals Over a Combiner Fiber and Wireless System” and filed on Jun. 20, 2006, the entirety of which is incorporated herein by reference.

### BACKGROUND OF THE INVENTION

1. Field of the Invention

The present invention is generally related to generalized content distribution systems. More particularly, the present invention is directed to a system, method and apparatus for transmitting high definition (HD) signals over a combined fiber and wireless system.

2. Background

High Definition (HD) signals are typically transmitted from one system to another using cables carrying DVI (Digital Video Interface) or HDMI (High Definition Multimedia Interface) signals.

Conventionally, DVI/HDMI signals are conveyed using a signaling scheme known as Transition Minimized Differential Signaling (TMDS). In TMDS, video, audio, and control data are carried as a series of 24-bit words on three TMDS data channels with a separate TMDS channel for carrying clock information. Additionally, DVI/HDMI systems may include a separate bi-directional channel known as the Display Data Channel (DDC) for exchanging configuration and status information between a source and a sink, including information needed in support of High-Bandwidth Digital Content Protection (HDCP) encryption and decryption. In HDMI, an optional Consumer Electronic Control (CEC) protocol provides high-level control functions between audiovisual products.

TMDS was initially designed for DVI/HDMI transmission over copper cables. However, the trend in DVI/HDMI systems is for using fiber optic cables instead of copper cables for distances spanning more than 5 meters.

In several respects, TMDS signaling is less than optimal for DVI/HDMI transmission over fiber. For example, DC-balancing and transition minimization characteristics of TMDS increase signaling overhead but provide little gain over fiber. Further, the BCH (Bose, Ray-Chaudhuri, Hocquenghem) code used in TMDS signaling is significantly inferior to other codes that provide greater error protection at lower overhead.

In another aspect, conventional DVI/HDMI systems continue to use bulky and expensive copper cables for conveying DDC information in the case of conventional DVI systems and DDC/CEC information in the case of conventional HDMI systems.

What is needed therefore is a system, method, and apparatus that reduces TMDS signaling overhead in DVI/HDMI transmission over fiber while providing greater error protection. What is further needed is to eliminate the bulky and expensive copper cables used for conveying DDC information in conventional DVI systems and for conveying DDC/CEC information in conventional HDMI systems.

### BRIEF SUMMARY OF THE INVENTION

The present invention is directed to a system, method, and apparatus for improving the efficiency of HD content delivery systems. An embodiment of the present invention eliminates unnecessary encoding overhead due to TMDS encoding in HD content delivery systems. Additionally, an embodiment of the present invention provides increased error protection at lower overhead in HD content delivery systems. Furthermore, embodiments of the present invention provide less expensive and more efficient techniques for transmitting content protection information in HD content delivery systems.

The present invention is applicable to HD content delivery systems such as DVI and HDMI systems, including systems that employ novel data transmission techniques as will be described herein as well as conventional content delivery systems. The present invention is also applicable to copper and fiber HD content delivery systems.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 illustrates a conventional DVI content delivery system.

FIG. 2 illustrates a conventional HDMI content delivery system.

FIG. 3 illustrates a conventional DVI fiber content delivery system.

FIG. 4 illustrates a conventional HDMI fiber content delivery system.

FIG. 5 illustrates a single fiber DVI content delivery system.

FIG. 6 illustrates a single fiber HDMI content delivery system.

FIG. 7 illustrates a single fiber DVI content delivery system with wireless Display Data Channel (DDC) and end-to-end High Definition Digital Content Protection (HDCP) without error concealment.

FIG. 8 illustrates a single fiber DVI content delivery system with wireless DDC and three HDCP sessions with error concealment.

FIG. 9 illustrates a single fiber HDMI content delivery system with wireless DDC/CEC and end-to-end HDCP without error concealment.

FIG. 10 illustrates one implementation according to the present invention for wirelessly implementing the DDC channel in a DVI/HDMI content delivery system.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### A. Overview

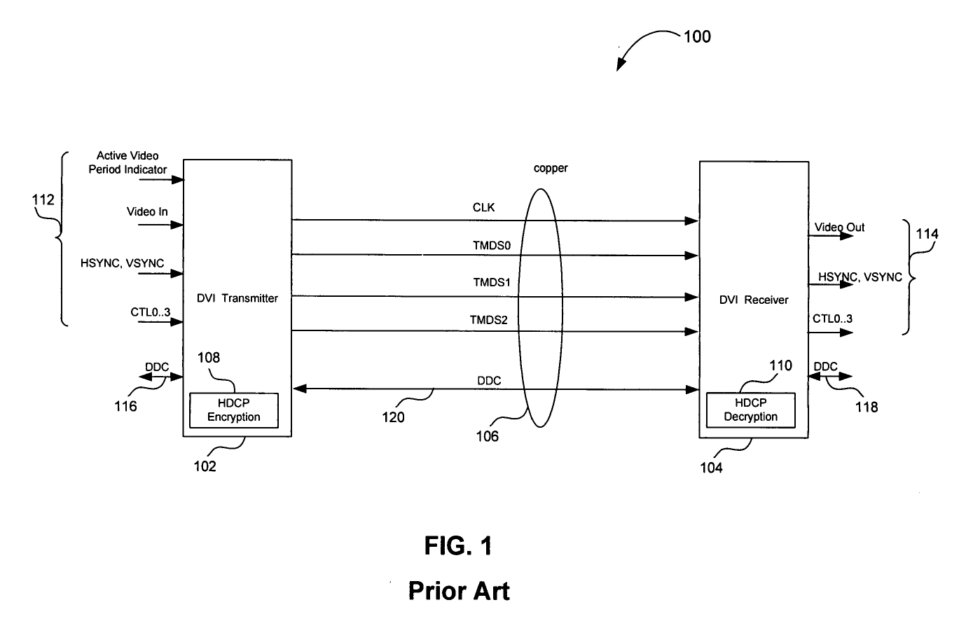

FIG. 1 illustrates a conventional DVI (Digital Video Interface) content delivery system 100. DVI system 100 includes a DVI transmitter 102 and a DVI receiver 104 connected by a DVI link 106. DVI link 106 is used to convey video information from DVI transmitter 102 to DVI receiver 104. Typically, DVI link 106 is a copper cable with DVI signals transmitted over the link using the Transition Minimized Differential Signaling (TMDS) scheme. In accordance with TMDS, video and control data are carried as a series of 24-bit words on three TMDS data channels with a separate TMDS channel used for carrying clock information. This is illustrated in FIG. 1 using channels TMDS0, TMDS1, TMDS2, and CLK. In an embodiment, the 24-bit words are protected using High-Bandwidth Digital Content Protection (HDCP), enabled by a HDCP Encryption module 108 at DVI transmitter 102 and a HDCP decryption module 110 at DVI receiver 104. HDCP provides protection against unauthorized reproduction of copyrighted content. TMDS encoding converts the HDCP-encrypted 8 bits per channel into 10 bits providing DC-balancing, transition minimization, and error protection via a BCH code.

Additionally, DVI system 100 includes a separate bi-directional channel 120 known as the Display Data Channel (DDC), which is used for configuration and status exchange between DVI transmitter 102 and DVI receiver 104. This configuration exchange may include information needed in support of HDCP.

As shown in FIG. 1, DVI transmitter 102 receives video and control signals 112 in the form of an Active Video Period Indicator signal, a Video In signal, HSYNC and VSYNC signals, and control signals CTL0-3. DVI transmitter 102 applies HDCP encryption to the received video and control signals 112, encodes the encrypted signals using TMDS, and transmits the encoded signals over the copper DVI link 106. DVI receiver 104 receives the transmitted DVI signals, removes the TMDS encoding, and performs HDCP decryption to generate the video and control signals 114. In the absence of transmission errors, video and control signals 114 are identical to video and control signals 112 (except that signals 114 contain no Active Video Period Indicator signal). Concurrently, configuration and status signals 116 and 118 are exchanged between DVI transmitter 102 and DVI receiver 104 over DDC channel 120 of DVI link 106. Note that the exchange on DDC channel 120 may occur from DVI transmitter 102 to DVI receiver 102, and vice versa.

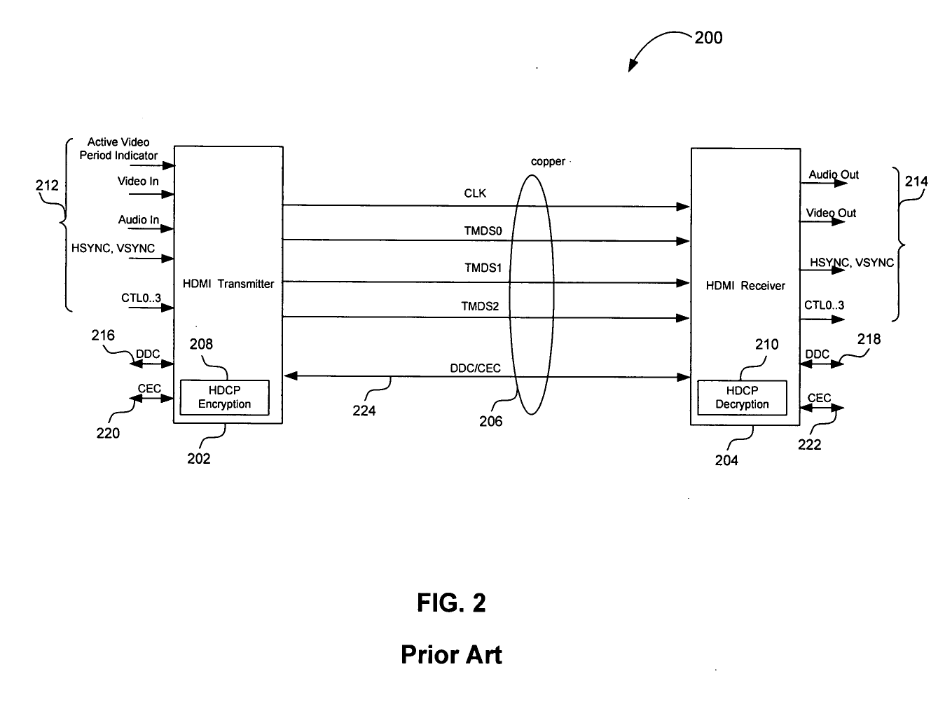

FIG. 2 illustrates a conventional HDMI content delivery system 200. HDMI system 200 is similar in several respects to DVI system 100 of FIG. 1, as will be appreciated by persons skilled in the art. HDMI system 200 includes an HDMI transmitter 202 and an HDMI receiver 204 connected by an HDMI link 206. HDMI link 206 is a copper cable, with HDMI signals transmitted over HDMI link 206 using TMDS, in a similar manner to that described above with respect to FIG. 1. Further, HDMI link 206 is HDCP protected by virtue of the operation of a HDCP Encryption module 208 at DVI transmitter 202 and a HDCP Decryption module 210 at DVI receiver 204.

In an embodiment, HDMI transmitter 202 receives video, audio (in the form of an Audio In signal) and control signals 212, as illustrated in FIG. 2. HDMI transmitter 202 applies HDCP encryption using HDCP encryption module 208 to the received signals 212, encodes the encrypted signals using TMDS, and then transmits the encoded signals over copper HDMI link 206. At the receiver end, HDMI receiver 204 receives the transmitted HDMI signals, removes the TMDS encoding, and performs HDCP decryption using HDCP Decryption module 210 to generate the video, audio and control signals 214. In the absence of transmission errors, video, audio, and control signals 214 are identical to video, audio, and control signals 212 (except that signals 214 contain no Active Video Period Indicator signal).

Similar to DVI system 100, configuration and status signals 216 and 218 are exchanged between HDMI transmitter 202 and HDMI receiver 204 over DDC channel 224 of HDMI link 206. Optionally, HDMI transmitter 202 and HDMI receiver 204 also exchange CEC information signals 220 and 222 over DDC channel 224, which is used to convey high-level control functions between audiovisual products. In an embodiment, the CEC information may be embedded together with the DDC information and transmitted over the same DDC/CEC channel of HDMI link 206.

### B. Conventional Fiber HD Content Delivery Systems

As described above with respect to systems 100 and 200, conventional DVI/HDMI systems employ copper cables for conveying information from one system to another. Using TMDS, DC-balancing and transition minimization can be achieved making copper cables efficient for DVI/HDMI systems spanning distances that are less than approximately 5 meters.

However, for longer distances, the impedance of copper cables causes large signal loss resulting in DVI and HDMI artifacts such as sparkles, pixilation, and loss of picture. While signal boosters and other approaches may be used over copper cables to reduce signal loss, these techniques are costly and not always effective. In contrast, relatively low cost fiber optic cables provide high quality transmissions at great distances due to the signal fidelity and noise immunity achievable over fiber. Further, fiber cables provide additional benefits compared to copper cables including longer lifetime and small cable size.

For these reasons, fiber optic cables are typically preferred over copper cables for long length DVI and HDMI signal extensions.

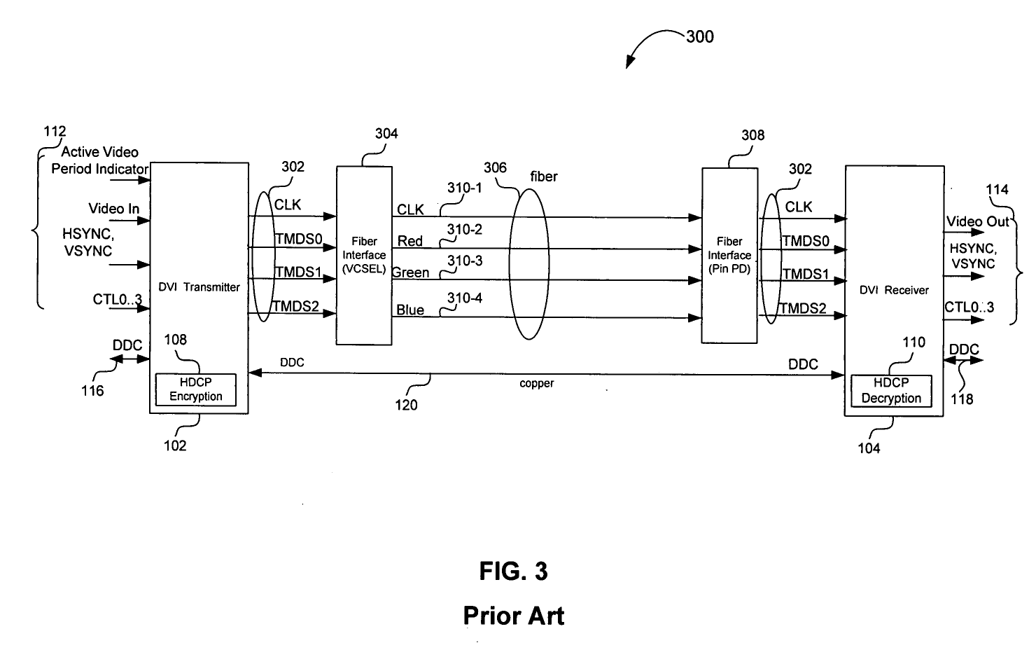

FIG. 3 illustrates a conventional DVI fiber content delivery system 300. Starting with TMDS encoded DVI signals 302, an optical transmitter 304 such as a 4-channel Vertical Cavity Surface Emitting Laser (VCSEL) is used to directly convert the TMDS encoded DVI signals 302 into 4 optical signals 310-{1, . . . ,4}. Optical signals 310-{1, . . . ,4} are transmitted as light pulses over 4 separate unidirectional fiber channels contained in fiber link 306. At the receiver side, an optical detector 308 such as a PIN or avalanche photodiode is used to convert each of fiber channels 310-{1, . . . ,4} back into a TMDS channel, thereby recovering the original TMDS encoded DVI signals 302.

Note that DDC channel 120 continues to be carried over a twisted pair of copper wires in DVI fiber system 300. This is generally acceptable, even for longer distances, given the low rate nature of DDC transmissions.

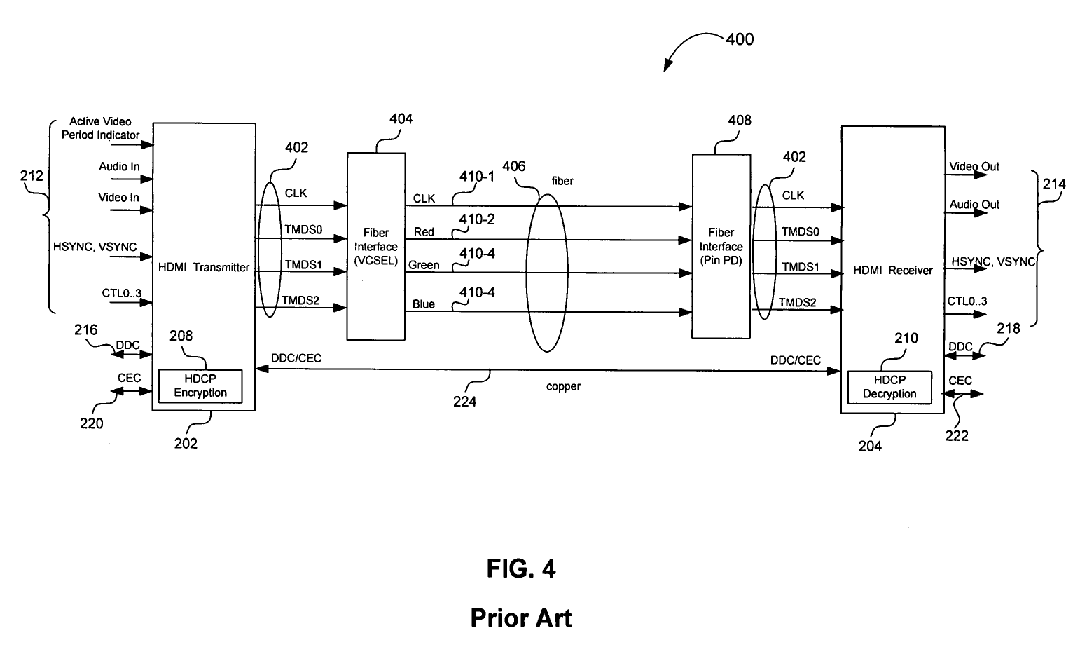

FIG. 4 illustrates a conventional HDMI fiber content delivery system 400. HDMI system 400 is substantially similar to DVI system 300 of FIG. 3, as will be understood by persons skilled in the art. Similar to DVI system 300, an optical transmitter 404 is used to convert TMDS encoded HDMI signals 402 into optical signals 410-{1, . . . ,4} and to transmit optical signals 410-{1, . . . ,4} over 4 separate unidirectional fiber channels. The 4 unidirectional fiber channels are contained in a fiber link 406. At the receiver side, an optical receiver 408 is used to recover optical signals 410-{1, . . . 4} and reconvert them into TMDS encoded signals 402, which are fed to HDMI receiver 204. The DDC/CEC channel 224 continues to be carried by copper cables in HDMI fiber system 400.

### C. Single Fiber HD Content Delivery Systems

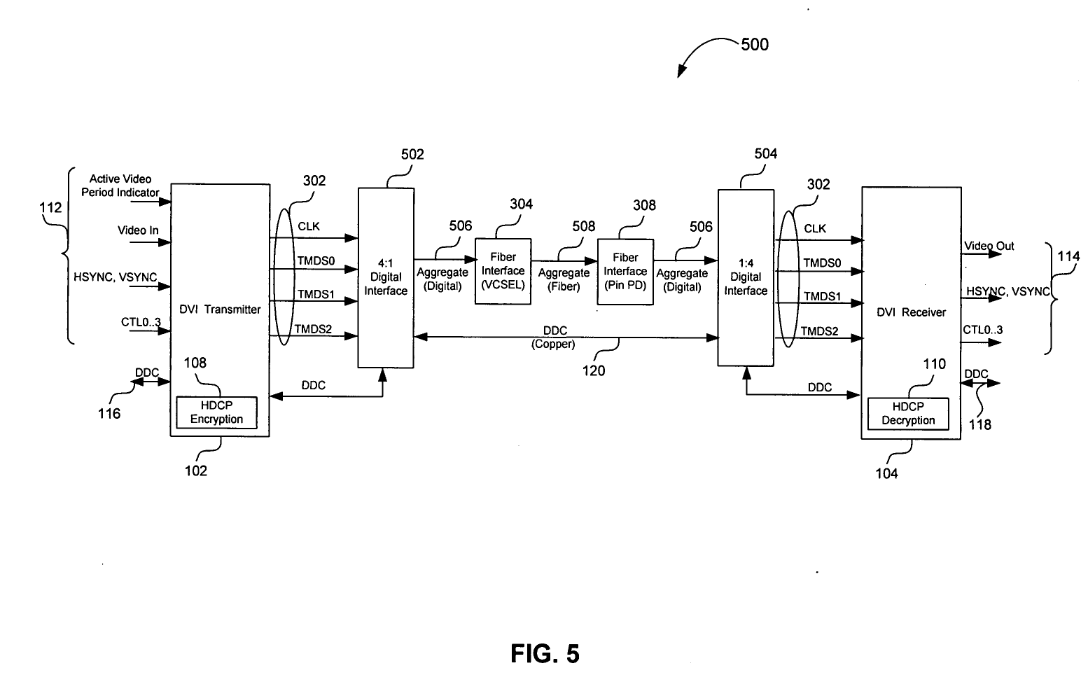

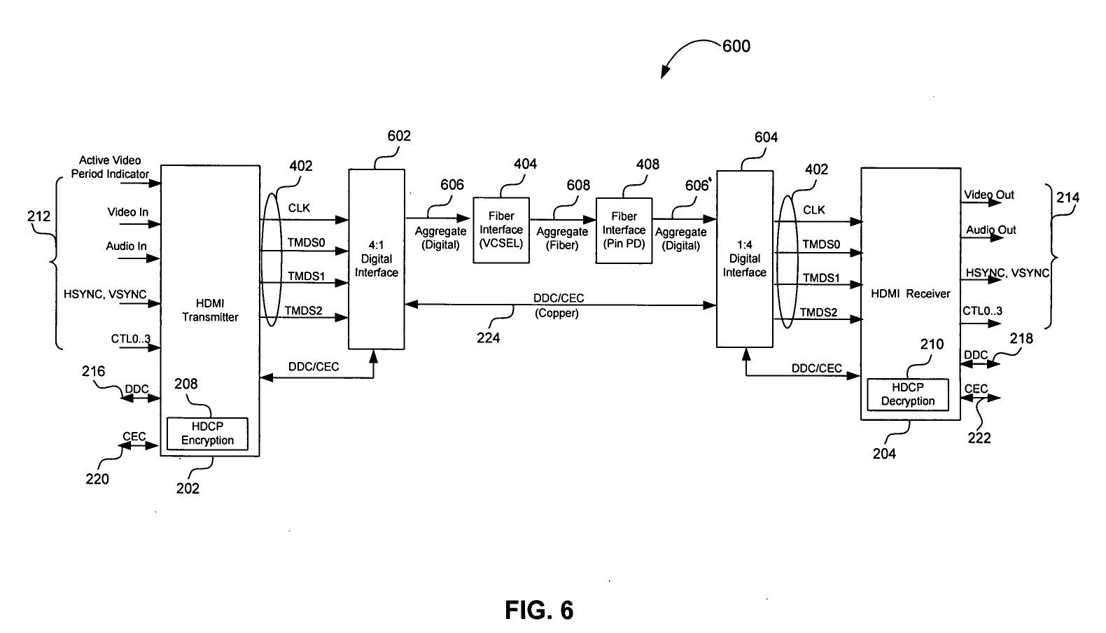

Conventional fiber DVI/HDMI systems may be further improved by aggregating the 4 TMDS encoded fiber channels into a single fiber link. This is illustrated in FIGS. 5 and 6, which respectively illustrate single fiber DVI and single fiber HDMI content delivery systems 500 and 600. In an embodiment, a 4:1 digital interface 502 (602) is used between DVI transmitter 102 (HDMI transmitter 202) and optical transmitter 304 (404) to multiplex the 4 TMDS encoded signals 302 (402) onto a single aggregate digital signal 506 (606). Aggregate digital signal 506 (606) is then optically converted by optical transmitter 304 (404) and transmitted over an aggregate fiber channel 508 (608). At the receiver side, an optical receiver 308 (408) re-generates aggregate digital signal 506 (606), before providing it to a 1:4 digital interface 504 (604) which re-generates the 4 multiplexed TMDS encoded signals 302 (402).

Note that using an aggregate fiber channel 508 (608) simplifies the DVI/HDMI content delivery system by allowing for the use of a one-channel laser and photodiode. On the other hand, aggregate fiber channel 508 (608) typically has a higher data rate, often necessitating more expensive fiber, laser, and photodiode.

It is noted that DDC channel 120 of system 500 and DDC/CEC channel 224 of system 600 still require a separate transmission medium, which typically includes a twisted pair of copper wires.

### D. Improved Single Fiber HD Content Delivery System

As described above, conventional DVI/HDMI fiber content delivery systems continue to employ TMDS encoding for conveying information. TMDS, however, initially designed for copper cables, provides little gain in fiber systems but results in added encoding overhead.

It is desirable to reduce the amount of overhead due to TMDS encoding in fiber systems, especially in single fiber HD systems which use a high data rate aggregate fiber channel. This is the case because reducing the amount of overhead allows for a reduction in the required data rate of the aggregate channel, thereby allowing for system operation using less-expensive and less-bulky components such as lasers, fibers, and photodiodes.

Additionally, error protection as provided by TMDS using a BCH code is considerably inferior compared to error protection using other types of codes with lower overhead such as low density parity check (LDPC) codes, for example. It is therefore desirable to provide greater error protection for data transmissions while reducing the overhead due to the error protection code.

Further, conventional DVI/HDMI systems continue to use bulky and expensive copper cables for conveying DDC information in the case of DVI and DDC/CEC information in the case of HDMI.

Enhanced fiber HD content delivery systems are therefore desired.

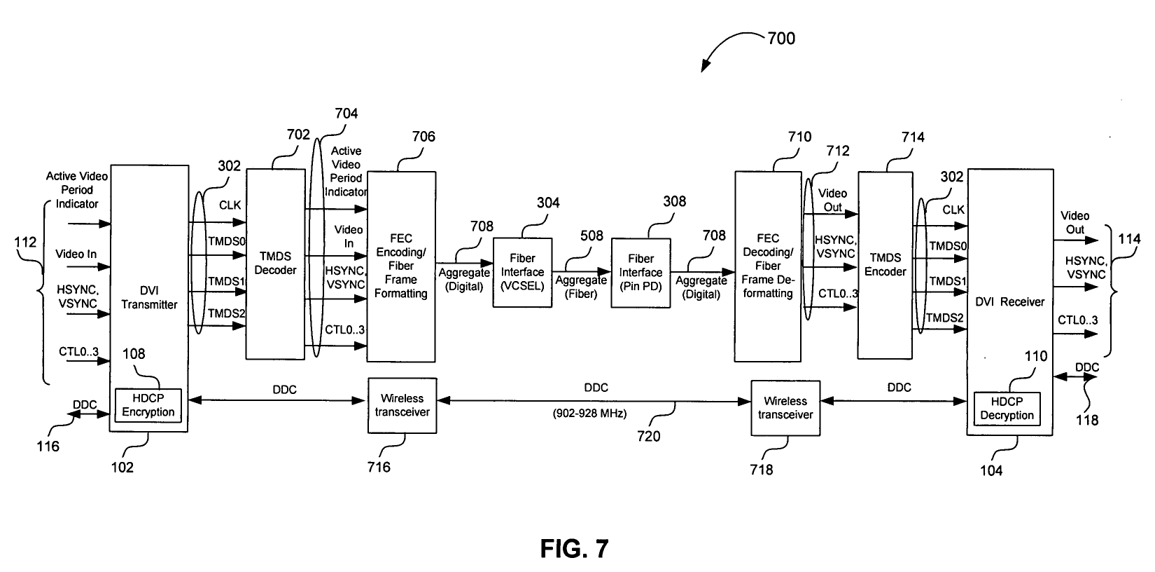

FIG. 7 illustrates a single fiber DVI content delivery system 700 with wireless Display Data Channel (DDC) and end-to-end High Definition Digital Content Protection (HDCP) without error concealment, in accordance with an embodiment of the present invention. DVI system 700 uses a TMDS decoder 702 at the transmitter side, which removes the TMDS encoding and re-generates the underlying HDCP-encrypted video and control information 704. Subsequently, Forward Error Correction (FEC) and/or Fiber Frame Formatting, customized for optical transmissions, is applied to video and control information 704 using FEC Encoding/Fiber Frame Formatting module 706. In an embodiment, a rate ⅞, length 8192 low density parity check (LDPC) code is applied for video data and a variable length and rate Reed-Solomon (RS) code is applied for control information to provide error protection. Typically, the length of the RS code depends on the amount of control information to be transmitted in a particular vertical blanking interval (VBI). As such, no additional overhead is added for DC-balancing or transition minimization, resulting in an aggregate data rate of aggregate digital signal 708 substantially lower than required to convey TMDS encoded signals. This allows for cost reduction in terms of the optical components (lasers, fibers, and photodiodes) of the system.

At the receiver side of system 700, once aggregate digital signal 708 is recovered by optical receiver 308, LDPC and RS decoders are applied to recover the video and control information 712 respectively. These operations are performed by FEC Decoding/Fiber Frame De-Formatting module 710. Subsequently, the FEC decoded video and control information 712 is fed to a TMDS encoder 714, which regenerates TMDS signals 302 and passes these TMDS signals to DVI receiver 104.

Note that in system 700, a single fiber 508 is used to convey the FEC encoded information from DVI transmitter 102 to DVI receiver 104. Accordingly, FEC encoding is applied to an aggregate signal onto which are multiplexed alternating samples from each of the 4 TMDS decoded outputs 704, to generate aggregate digital signal 708. Alternatively, in a system using separate fiber channels for each of TMDS decoded outputs 704, separate FEC encoders and decoders can be used for each channel.

In addition to reducing overhead due to TMDS encoding and error protection, DVI system 700 uses a wireless channel 720 to convey DDC information. This eliminates the expensive and bulky copper cables used in conventional systems. In an embodiment, a wireless channel in the 902-928 MHz frequency band is used to communicate DDC information between DVI transmitter 102 and DVI receiver 104. Note that the 902-928 MHz band is an FCC regulated ISM frequency band that supports reliable transmissions over long distances in the United States. Alternatively, other frequency allocations may be used according to local regulatory conditions. For example, the 868 MHz ISM band can be used in Europe.

In an embodiment, DDC information is sent from DVI transmitter 102 to a wireless transceiver 716 at the transmitter side, which encodes the information for wireless transmission and transmits the information over wireless channel 720. A wireless transceiver 718 at the receiver side receives the wireless information and re-generates the DDC information, before sending it to DVI receiver 104. It is noted that DDC channel 720 is bidirectional, and therefore DDC information may also be transmitted in the receiver-to-transmitter direction.

In other embodiments, the DDC information is multiplexed together with video and control information on aggregate fiber channel 508 in the transmitter-to-receiver direction, and carried wirelessly in the receiver-to-transmitter direction, or vice versa.

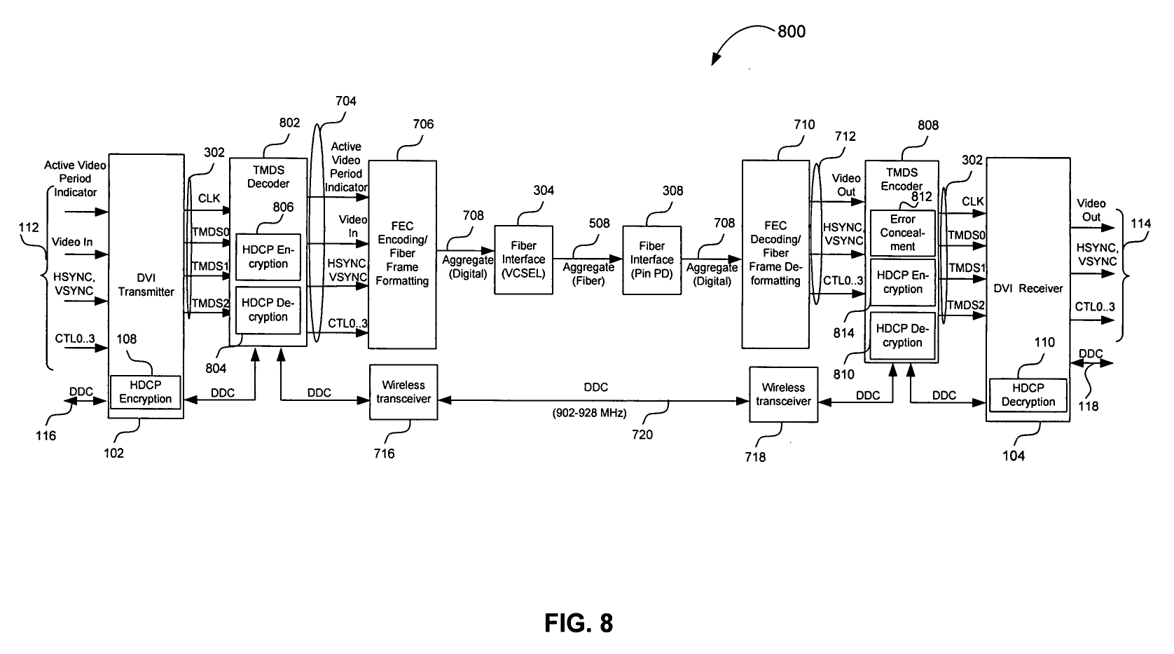

DVI system 700 uses no error concealment. However, as will be illustrated in the variant system of FIG. 8, error concealment can be implemented, for example, in the TMDS encoder at the receiver side. In such an embodiment, data from the LDPC and RS decoders (FEC Decoding module 710) indicating the reliability of the decoded video can be used for video error concealment. For example, if the LDPC decoder marks a video pixel as being in error, that pixel can be estimated from surrounding pixels that are known to be reliable.

The ability to perform error concealment is determined by the particular HDCP configuration. This is because the HDCP configuration determines whether or not raw (i.e., unencrypted) video samples are available for error concealment. Typically, HDCP encryption performs an XOR operation on the data, making error concealment impossible prior to HDCP decryption. The present invention can be used with many HDCP variants.

In DVI system 700, HDCP encryption is applied end-to-end from DVI transmitter 102 to DVI receiver 104. Therefore, there can be no error concealment at TMDS encoder 714 because FEC decoded video and control signals 712 remain HDCP-encrypted at TMDS encoder 714.

In system 800 of FIG. 8, a first HDCP session is initiated using HDCP Encryption module 108 at DVI transmitter 102 and terminated at TMDS decoder 802 using HDCP Decryption module 804, a second HDCP session is initiated using HDCP Encryption module 806 at TMDS decoder 802 and terminated at TMDS Encoder 808 using HDCP Decryption module 810, before a third HDCP session is initiated using HDCP Encryption module 814 at TMDS encoder 808 and terminated at DVI receiver 104 using HDCP Decryption module 110. As such, raw (i.e., unencrypted) data is available at TMDS encoder 808 at the termination of the second HDCP session, allowing for error concealment to be performed before TMDS encoder 808 initiates the third HDCP session.

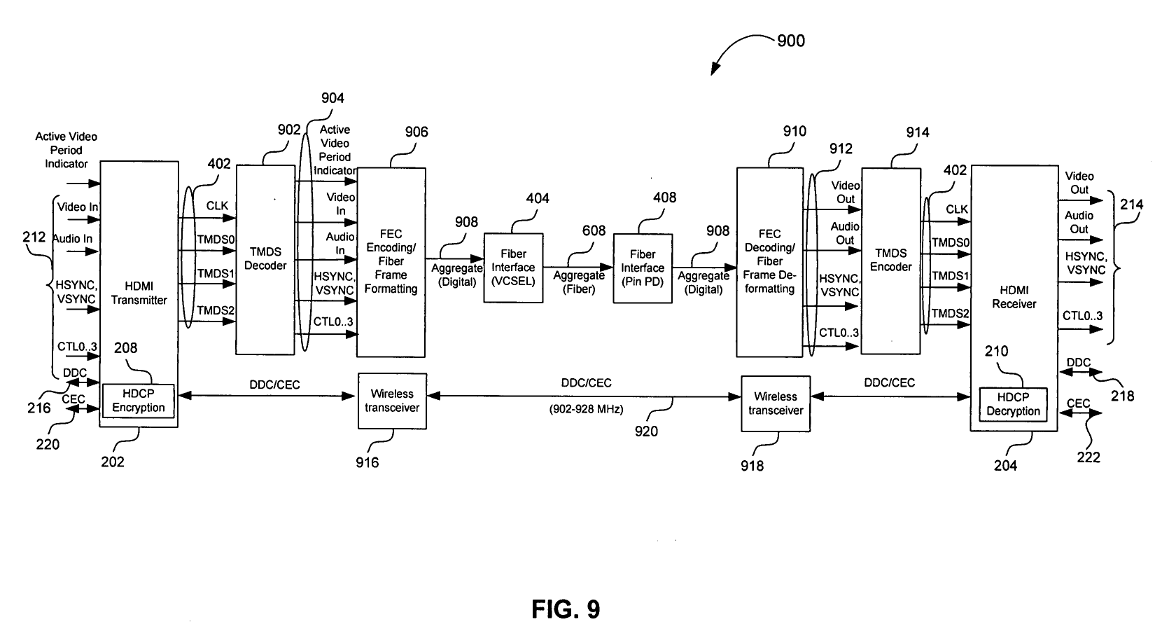

It is noted that the above described DVI systems of FIGS. 7 and 8 may be equivalently implemented as HDMI systems, including all of the above described embodiments thereof. FIG. 9 illustrates, for example, a single fiber HDMI content delivery system 900 with wireless DDC/CEC and end-to-end HDCP without error concealment, similar to DVI system 700 of FIG. 7.

HDMI system 900 uses a TMDS decoder 902 at the transmitter side, which removes the TMDS encoding and re-generates HDCP-encrypted audio, video and control signals 904. Subsequently, Forward Error Correction (FEC) and/or Fiber Frame Formatting, customized for optical transmissions, are applied to audio, video and control signals 904. In an embodiment, a rate ⅞, length 8192 low density parity check (LDPC) code is applied for video data and a variable length and rate Reed-Solomon (RS) code is applied for audio and control information to provide error protection. Typically, the length of the RS code depends on the amount of control information to be transmitted in a particular audio/video (AV) line. As such, no additional overhead is added for DC-balancing or transition minimization, resulting in an aggregate data rate of aggregate digital signal 908 substantially lower than required to convey TMDS encoded signals. This allows for cost reduction in terms of the optical components (lasers, fibers, and photodiodes) of the system.

At the receiver side of system 900, LDPC and RS decoders are applied to recover video, audio, and control signals 912. This is illustrated using the FEC Decoding/Fiber Frame De-Formatting module 910 in FIG. 9. Note that signals 912 should be identical to respective signals 904 (except that signals 912 contain no Active Video Period Indicator signal), unless uncorrectable errors occur in transmission. Subsequently, FEC decoded video, audio and control signals 912 are fed to a TMDS encoder 914, which regenerates TMDS signals 402 and passes these TMDS signals to HDMI receiver 204.

Note that in system 900, a single fiber is used to convey the FEC encoded information from HDMI transmitter 202 to HDMI receiver 204. Accordingly, FEC encoding is applied to an aggregate signal onto which are multiplexed alternating samples from each of the 5 TMDS decoded outputs 904, to generate aggregate signal 908. Alternatively, in a system using separate fiber channels for each of TMDS decoded outputs 904, separate FEC encoders and decoders can be used for each channel. Alternatively, the TMDS outputs 904 can be grouped into one or more outputs per group and separate FEC encoders and decoders used on each grouped signal.

In addition to reducing overhead due to TMDS encoding and error protection, HDMI system 900 uses a wireless channel 920 to convey the DDC/CEC information. This eliminates the expensive and bulky copper cables used in conventional systems. In an embodiment, a wireless channel in the 902-928 MHz frequency band is used to communicate DDC/CEC information between the HDMI transmitter and the HDMI receiver. Note that the 902-928 MHz band is an FCC regulated ISM frequency band that supports reliable transmissions over long distances in the United States. Alternatively, other frequency allocations may be used according to local regulatory conditions. For example, the 868 MHz ISM band can be used in Europe.

In an embodiment, DDC/CEC information is sent from HDMI transmitter 202 to a wireless transceiver 916 at the transmitter side, which encodes the information for wireless transmission and transmits the information over wireless channel 920. At the receiver side, a wireless transceiver 918 receives the wireless information and re-generates the DDC/CEC information, before sending it to HDMI receiver 204. It is noted that DDC channel 920 is bidirectional, and therefore DDC information may also be transmitted in the receiver-to-transmitter direction

In other embodiments, the DDC/CEC information is multiplexed together with video, audio, and control information on aggregate fiber channel 608 in the transmitter-to-receiver direction and carried wirelessly in the receiver-to-transmitter direction, or vice versa.

HDMI system 900 of FIG. 9 uses no error concealment. However, error concealment could be implemented if a different HDCP configuration were used that made raw (i.e., unencrypted) audio and video samples available at TMDS encoder 914. Such an HDCP configuration is illustrated in DVI system 800 of FIG. 8, and can be readily extended to an HDMI system. In such an embodiment, data from the LDPC and RS decoders (FEC Decoding module 910) indicating the reliability of the decoded video and audio could be used for video and audio error concealment. For example, if the LDPC decoder marked a video pixel as being in error, that pixel could be estimated from surrounding pixels that are known to be reliable.

### E. Combined Fiber and Wireless Content Delivery Systems

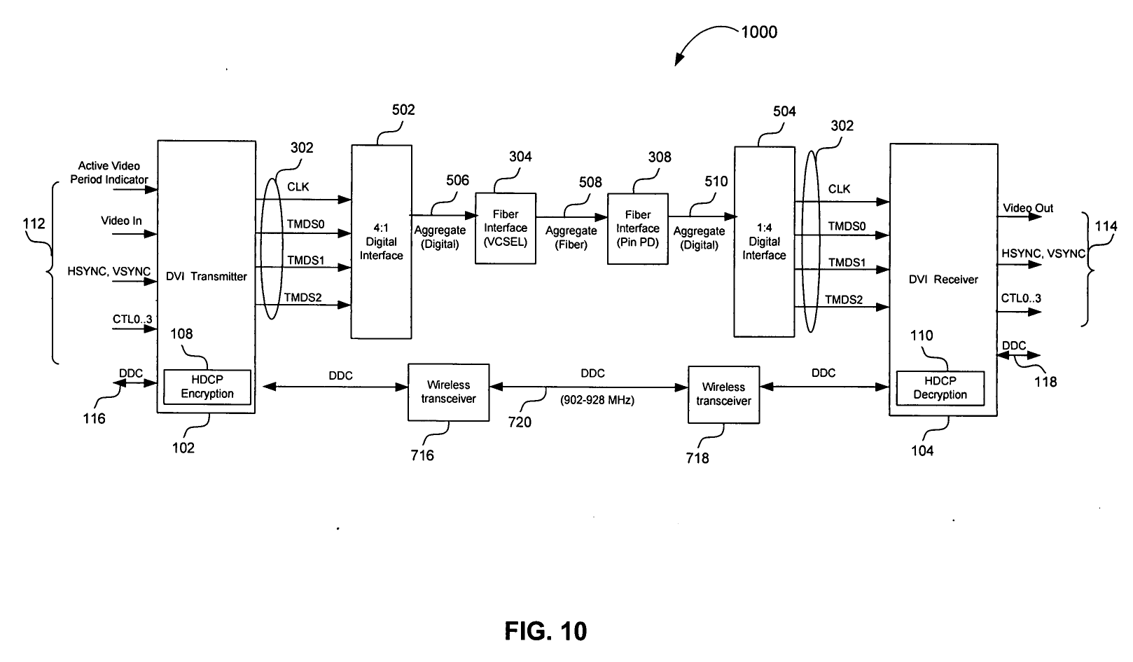

As described above with respect to various embodiments according to the present invention, the DDC/CEC channel can be implemented wirelessly either uni-directionally or bi-directionally, eliminating the need for expensive and bulky copper cables. This advantage according to the present invention is not limited to systems employing embodiments of the present invention for transmitting audio, video, and control information, but can be extended to conventional fiber and copper content delivery systems. FIG. 10, for example, illustrates a fiber DVI system 1000 that wirelessly implements the DDC channel 720. This can be similarly extended to conventional copper DVI systems or to conventional HDMI fiber/copper systems.

### D. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method for transmitting signals in a high definition (HD) content delivery system, comprising:
receiving TMDS (Transition Minimized Differential Signaling) encoded HD signals;
decoding said TMDS encoded HD signals to generate multimedia signals;
encoding said multimedia signals according to a Forward Error Correction (FEC) scheme;
transmitting said FEC encoded signals over a link of the content delivery system;
receiving said FEC encoded signals and decoding said FEC encoded signals to retrieve said multimedia signals;
re-encoding said raw multimedia signals according to TMDS and delivering said re-encoded signals to a HD receiver.

2. The method of claim 1, wherein said link of the content delivery system includes a fiber optic cable.

3. The method of claim 2, wherein said FEC scheme is optimized for optical fiber transmission.

4. The method of claim 1, wherein said link of the content delivery system includes an aggregate fiber channel.

5. The method of claim 1, wherein said link of the content delivery system includes a plurality of separate fiber channels.

6. The method of claim 1, further comprising:
transmitting configuration and control information over a control channel.

7. The method of claim 6, wherein said control channel is aggregated together with said FEC encoded signals over said link of the content delivery system

8. The method of claim 6, wherein said control channel is aggregated, when in the direction to said HD receiver, together with said FEC encoded signals over said link of the content delivery system.

9. The method of claim 6, wherein said control channel is carried over a separate link of said content delivery system, when in the direction from said HD receiver.

10. The method of claim 6, wherein said control channel includes a Display Data Channel (DDC).

11. The method of claim 6, wherein said control channel includes a Consumer Electronics Control (CEC) channel.

12. The method of claim 1, further comprising:
encrypting said multimedia signals according to a High-bandwidth Digital Content Protection (HDCP) scheme.

13. The method of claim 12, further comprising:
decrypting the HDCP encrypted signals at a HD receiver.

14. The method of claim 13, wherein said decrypting step is performed after the re-encoding step.

15. The method of claim 13, wherein said decrypting step is performed prior to the re-encoding step, thereby allowing for error concealment.

16. The method of claim 6, wherein said control channel includes a wireless channel.

17. The method of claim 16, wherein said wireless channel is bi-directional.

18. The method of claim 16, wherein said wireless channel is unidirectional.

19. A method for communicating signals in a content delivery system, comprising:
receiving TMDS (Transition Minimized Differential Signaling) encoded signals;
decoding said TMDS encoded signals to generate multimedia signals;
transmitting said multimedia signals over a fiber link of the content delivery system;
receiving said multimedia signals over the link; and
re-encoding the multimedia signals according to TMDS.

20. A method for receiving signals in a content delivery system, comprising:
receiving multimedia signals encrypted in accordance with a High-bandwidth Digital Content Protection (HDCP) scheme;
decrypting said HDCP-encrypted multimedia signals to generate decrypted multimedia signals;
performing error concealment on said decrypted multimedia signals to generate corrected multimedia signals;
re-encrypting said corrected multimedia signals in accordance with said HDCP scheme;
passing said re-encrypted multimedia signals to a receiver.

21. The method of claim 20, wherein said receiving said multimedia signals encrypted in accordance with said HDCP scheme comprises performing Transition Minimized Differential Signaling (TMDS) decoding of said HDCP-encrypted multimedia signals; and
wherein passing said re-encrypted multimedia signals to a receiver comprises performing TMDS encoding of said re-encrypted multimedia signals.

22. A method for transmitting signals in a high definition (HD) media content delivery system, comprising:
transmitting signals representing HD media content over a wired medium; and
transmitting configuration and control information associated with said HD media content over a wireless medium.

23. The method of claim 22, wherein said wired medium comprises a fiber optic cable.

24. The method of claim 22, wherein said wired medium comprises a copper cable.

25. The method of claim 22, wherein said HD media content includes one or more of Digital Video Interface (DVI) and High Definition Multimedia Interface (HDMI) content.

26. The method of claim 22, wherein said configuration and control information includes Display Data Channel (DDC) information.

27. The method of claim 22, wherein said configuration and control information includes Consumer Electronics Control (CEC) information.

28. A high definition (HD) content delivery system, comprising:
an HD transmitter that transmits TMDS (Transition Minimized Differential Signaling) encoded multimedia signals;
a TMDS decoder, coupled to said HD transmitter, that decodes said TMDS encoded multimedia signals to generate raw multimedia signals;
an optical transmitter, coupled to said TMDS decoder, that optically transmits said raw multimedia signals over a fiber link to an optical receiver;
a TMDS encoder, coupled to said optical receiver, that TMDS re-encodes said raw multimedia signals to generate TMDS re-encoded signals; and
a HD receiver, coupled to said TMDS encoder, that receives said TMDS re-encoded multimedia signals.

29. The system of claim 28, further comprising:
a Forward Error Correction (FEC) encoder, coupled between said TMDS decoder and said optical transmitter; and
a FEC decoder, coupled between said optical receiver and said TMDS encoder,
wherein said FEC encoder encodes said raw multimedia signals according to an FEC scheme, and wherein said FEC decoder decodes said FEC encoded multimedia signals.

30. The system of claim 28, further comprising:
a first and second wireless transceivers, linked by a wireless channel, wherein the first wireless transceiver is coupled to said HD transmitter and the second wireless transceiver is coupled to said HD receiver.

31. The system of claim 29, further comprising:
a multiplexer, coupled between said TMDS decoder and said FEC encoder, that generates an aggregate signal of said raw multimedia signals; and
a de-multiplexer, coupled between said FEC decoder and said TMDS encoder, that de-multiplexes said aggregate signal to re-generate said raw multimedia signals.

32. The system of claim 28, wherein said HD transmitter comprises a High-Bandwidth Digital Content Protection (HDCP) module that HDCP-encrypts said TMDS encoded signals, and
wherein said HD receiver comprises a HDCP decryption module that HDCP-decrypts said TMDS re-encoded signals.

33. The system of claim 28, wherein said HD transmitter comprises a HDCP module that HDCP-encrypts said TMDS encoded signals, and
wherein said TMDS decoder comprises a HDCP decryption module that HDCP-decrypts said HDCP-encrypted TMDS encoded signals, to re-generate said TMDS encoded signals.

34. The system of claim 33, wherein said TMDS decoder comprises a HDCP encryption module that HDCP encrypts said raw multimedia signals, and
wherein said TMDS encoder comprises a HDCP encryption module that HDCP-decrypts said raw multimedia signals, to re-generate said raw multimedia signals

35. The system of claim 34, wherein said TMDS encoder comprises an error concealment module that performs error concealment on said raw multimedia signals.

36. The system of claim 34, wherein said TMDS encoder comprises a HDCP encryption module that HDCP re-encrypts said raw multimedia signals, and
wherein said HD receiver comprises a HDCP encryption module that HDCP decrypts said TMDS re-encoded signals.
